(19) United States
(12) Patent Application Publication
(10) Pub. No.: US 2026/0079347 A1
(43) Pub. Date: Mar. 19, 2026

(54) LIGHTGUIDE INCLUDING PARTIAL REFLECTORS WITHIN ENCAPSULATING POLYMER LAYER, VISUAL AUGMENTED REALITY DEVICE INCLUDING SAME, AND METHOD OF MAKING SAME

(71) Applicant: CORNING INCORPORATED, CORNING, NY (US)

(72) Inventors: Dmitri Vladislavovich Kuksenkov, Elmira, NY (US); David August Sniezek Loeber, Horseheads, NY (US)

(21) Appl. No.: 19/323,419

(22) Filed: Sep. 9, 2025

Related U.S. Application Data
(60) Provisional application No. 63/696,590, filed on Sep. 19, 2024.

(51) Int. Cl. G02B 27/01

(52) U.S. Cl. CPC G02B 27/0172

(57) ABSTRACT

A lightguide for a visual augmented reality device includes: (a) a glass substrate having a first glass primary surface, a second glass primary surface, and a glass thickness, the first glass primary surface and the second glass primary surface facing in generally opposite directions; (b) an encapsulating polymer layer disposed on the first glass primary surface, the encapsulating polymer layer including a first polymer primary surface, a second polymer primary surface facing the first glass primary surface, and a polymer thickness between the first polymer primary surface and the second polymer primary surface, the first polymer primary surface and the second polymer primary surface facing in generally opposite directions; and (c) partial reflectors disposed within the polymer thickness, the partial reflectors disposed at an oblique angle relative to the first primary glass surface. The glass substrate is free of adhesive disposed within the glass thickness.

This application claims the benefit of priority to U.S. Provisional Patent Application Ser. No. 63/696,590 filed on Sep. 19, 2024, the content of which is relied upon and incorporated herein by reference in its entirety.

### TECHNICAL FIELD

The present disclosure pertains to a lightguide for a visual augmented reality device and, more particularly, to a lightguide that includes a polymer layer on a glass substrate and partial reflectors within the polymer layer.

### BACKGROUND

Visual augmented reality combines real-world and computer-generated imagery. For example, head mounted displays and eyeglass type devices include transparent components into which or onto which an image source projects computer-generated imagery. The wearer then sees both the real-world imagery transmitted through the transparent components to the eyes and the computer-generated imagery overlayed onto the real-world imagery.

The transparent component typically transmits the computer-generated imagery to the eyes of the user via internal reflection and thus will hereinafter be referred to as a lightguide. The image source, such as an LCD, OLED, or some other micro-display, generates the image. The image is then directed into the lightguide, such as with a prism coupled to a primary surface of the lightguide or via diffractive elements (e.g., gratings), at an edge of the lightguide. The lightguide then guides the image via internal reflection to in front of where the eyes of the user are intended to be. The lightguide includes features, such as internal partially reflecting surfaces, that direct the image from the lightguide toward the eyes of the user.

In one way to make the lightguide, numerous transparent flat glass plates with a reflective surface coated thereupon are formed. The glass plates with the reflecting surfaces are laminated together with an adhesive to form a stack. The stack is then sliced, ground, and polished at an angle oblique to the primary surface of the top glass plate of the stack. The sliced portion of the stack represents the lightguide. That approach can be seen at FIG. 20 of U.S. Pat. No. 9,977,244B2. In another way, two sawtooth shaped transparent forms, as a positive and negative of each other, are made via injection-molding or casting. The two sawtooth forms are glued together with premade reflecting surfaces sandwiched between the teeth of the transparent forms. That approach can be seen at FIG. 22 of the same patent.

However, there is a problem in that those ways to manufacture the lightguide with internal partially reflecting surfaces are suboptimal in terms of complexity, materials utilized, scrap formed, cost, and scalability. The first described way requires the formation of many layers, utilizes adhesive, and generates waste from portions of the layers from which a lightguide slice cannot be obtained. The layering of the glass plates and slicing at an angle to obtain the lightguide takes a lot of time and requires precision in the cutting, grinding, and polishing of the stack. The portions of the stack not forming the lightguide sliced therefrom are destroyed as scrap. Further, because the internal partially reflecting surfaces extend through the lightguide from primary surface to primary surface, the lightguide will be susceptible to delamination upon application of a bending force to the lightguide.

The second described way requires the formation of several layers with sawtooth portions. The sawtooth containing layers limit the choice of materials. For example, a high-index glass (appropriate for internal reflection) might not be possible to cast and would be too expensive to grind and polish into a sawtooth shape. Even if expense were not an issue, grinding and polishing the two transparent pieces as exact negatives of each other would be extremely difficult. Failure to have exact matching of the sawtooth shapes when glued together would generate observable air pockets between the layers, which would decrease aesthetics and detract from performance. Further, the use of adhesive to sandwich the premade partially reflective portions between the two transparent pieces is an added expense.

### SUMMARY

The present disclosure addresses that problem, among other ways, with a lightguide with a glass substrate, a polymer layer on the glass substrate, and partial reflectors disposed within the polymer layer. The partial reflectors do not extend from primary surface to primary surface of the lightguide. Rather, in embodiments, the partial reflectors are disposed within the polymer layer and are not exposed to cither primary surface of the lightguide. Thus, there is no issue with the partial reflectors making the lightguide susceptible to delamination upon application of a bending force. Further, the polymer layer is formed in several steps, with a first polymer region added over the glass substrate and then a sawtooth shape molded or imprinted into the first polymer region. The partial reflectors are then added to the proper (angled) surfaces of the sawtooth shapes. A second polymer region is then added over the first polymer region thus sandwiching the partial reflectors between the first polymer region and the second polymer region. The second polymer region is added while the polymer has sufficiently low viscosity to flow and to self-level in order to fill spaces between the sawtooth portions of the first polymer region. Upon hardening, the second polymer region and the first polymer region form contiguously the polymer layer with no air gaps therewithin. The lightguide is thus more mechanically robust. The lightguide is easier and less expensive to make.

According to a first aspect of the present disclosure, a lightguide for a visual augmented reality device comprises: (a) a glass substrate comprising a first glass primary surface, a second glass primary surface, and a glass thickness between the first glass primary surface and the second glass primary surface, the first glass primary surface and the second glass primary surface facing in generally opposite directions; (b) an encapsulating polymer layer disposed on the first glass primary surface, the encapsulating polymer layer comprising a first polymer primary surface, a second polymer primary surface facing the first glass primary surface, and a polymer thickness between the first polymer primary surface and the second polymer primary surface, the first polymer primary surface and the second polymer primary surface facing in generally opposite directions; and (c) partial reflectors disposed within the polymer thickness, the partial reflectors disposed at an oblique angle relative to the first primary glass surface, wherein, the lightguide is free of adhesive disposed within the glass thickness.

According to a second aspect of the present disclosure, the lightguide of the first aspect is presented, wherein (i) the glass substrate exhibits a glass refractive index, (ii) the encapsulating polymer layer exhibits a polymer refractive index, and (iii) an absolute value of a difference between the glass refractive index and the polymer refractive index is less than 0.20.

According to a third aspect of the present disclosure, the lightguide of the second aspect is presented, wherein the absolute value of the difference between the glass refractive index and the polymer refractive index is less than 0.10.

According to a fourth aspect of the present disclosure, the lightguide of any one of the second through third aspects is presented, wherein the glass refractive index and the polymer refractive index are each within a range of from 1.40 to 2.30.

According to a fifth aspect of the present disclosure, the lightguide of any one of the first through fourth aspects is presented, wherein the encapsulating polymer layer comprises (i) a first polymer region contiguous with the first polymer primary surface and (ii) a second polymer region contiguous with the second polymer primary surface.

According to a sixth aspect of the present disclosure, the lightguide of the fifth aspect is presented, wherein the first polymer region and the second polymer region have the same polymer composition.

According to a seventh aspect of the present disclosure, the lightguide of the fifth aspect is presented, wherein the second polymer region and the first polymer region have different polymer compositions but exhibit indices of refraction that are substantially the same.

According to an eighth aspect of the present disclosure, the lightguide of any one of the fifth through seventh aspects is presented, wherein each of the partial reflectors is disposed between the first polymer region and the second polymer region.

According to a ninth aspect of the present disclosure, the lightguide of any one of the first through eighth aspects is presented, wherein the first glass primary surface over which the partial deflectors are disposed is non-planar.

According to a tenth aspect of the present disclosure, the lightguide of any one of the first through ninth aspects is presented, wherein each of the partial reflectors is curved.

According to an eleventh aspect of the present disclosure, the lightguide of any one of the first through tenth aspects is presented, wherein the partial reflectors are disposed substantially parallel to each other.

According to a twelfth aspect of the present disclosure, the lightguide of any one of the first through eleventh aspects is presented, wherein each of the partial reflectors comprises a glass facing side that forms an acute angle relative to the first glass primary surface.

According to a thirteenth aspect of the present disclosure, the lightguide of any one of the first through twelfth aspects is presented, wherein the partial reflectors comprise a first partial reflector, a last partial reflector, and additional partial reflectors disposed spatially between the first partial reflector and the last partial reflector.

According to a fourteenth aspect of the present disclosure, the lightguide of the thirteenth aspect is presented, wherein (i) each of the partial reflectors comprises a glass facing side that forms an acute angle relative to the first glass primary surface, and (ii) a value of the acute angle for the additional partial reflectors and the last partial reflector changes as a function of distance from the first partial reflector.

According to a fifteenth aspect of the present disclosure, the lightguide of the fourteenth aspect is presented, wherein the value of the acute angle for each of the partial reflectors is within a range of from 10 degrees to 45 degrees.

According to a sixteenth aspect of the present disclosure, the lightguide of any one of the thirteenth through fifteenth aspects is presented, wherein (i) each of the partial reflectors comprises alternating layers of a high-index material and a low-index material, and (ii) the high-index material exhibits an index of refraction that is greater than an index of refraction that the low-index material exhibits.

According to a seventeenth aspect of the present disclosure, the lightguide of the sixteenth aspect is presented, wherein (i) the index of refraction of the low-index material is within a range of from 1.40 to 1.65, and (ii) the index of refraction of the high-index material is within a range of from 1.66 to 2.60.

According to an eighteenth aspect of the present disclosure, the lightguide of any one of the sixteenth through seventeenth aspects is presented, wherein (i) the low-index material comprises one or more of SiO₂, MgF₂, YF₃, and YbF₃, and (ii) the high-index material comprises one or more of ZrO₂, HfO₂, Ta₂O₅, Nb₂O₅, TiO₂, Y₂O₃, Si₃N₄, SrTiO₃, WO₃, SiᵤAlᵥOₓN_{y}, AlNₓ, Si₃N₄, AlOₓN_{y}, SiOₓN_{y}, SiNₓ, SiNₓ: H_{y}, Al₂O₃, and MoO₃.

According to a nineteenth aspect of the present disclosure, the lightguide of any one of the sixteenth through eighteenth aspects is presented, wherein (i) each of the alternating layers comprises a layer thickness, and (ii) the layer thickness of each of the alternating layers is within a range of 10 nm to 250 nm.

According to a twentieth aspect of the present disclosure, the lightguide of the nineteenth aspect is presented, wherein the layer thickness of each of the alternating layers, the index of refraction of the low-index material, and the index of refraction of the high-index material are collectively configured so that the partial reflectors exhibit a predetermined reflectance of electromagnetic radiation at a wavelength within the visible spectrum.

According to a twenty-first aspect of the present disclosure, the lightguide of any one of the sixteenth through the twentieth aspects is presented, wherein the reflectance that the partial reflectors exhibit increases sequentially from the first partial reflector to the last partial reflector.

According to a twenty-second aspect of the present disclosure, the lightguide of the twenty-first aspect is presented, wherein the reflectance that the partial reflectors exhibit increases exponentially from the first partial reflector to the last partial reflector.

According to a twenty-third aspect of the present disclosure, the lightguide of any one of the twenty-first through twenty-second aspects is presented, wherein the reflectance that each of the partial reflectors exhibits is within a range of from greater than 0% to 80%.

According to a twenty-fourth aspect of the present disclosure, the lightguide of any one of the nineteenth through twenty-third aspects is presented, wherein the layer thickness of at least one of the alternating layers increases or decreases sequentially from the first partial reflector to the last partial reflector.

According to a twenty-fifth aspect of the present disclosure, a visual augmented reality device comprises: (1) a lightguide comprising: (a) a glass substrate comprising a first glass primary surface, a second glass primary surface, and a glass thickness between the first glass primary surface and the second glass primary surface, the first glass primary surface and the second glass primary surface facing in generally opposite directions; (b) an encapsulating polymer layer disposed on the first glass primary surface, the encapsulating polymer layer comprising a first polymer primary surface, a second polymer primary surface facing the first glass primary surface, and a polymer thickness between the first polymer primary surface and the second polymer primary surface, the first polymer primary surface and the second polymer primary surface facing in generally opposite directions; and (c) partial reflectors disposed within the polymer thickness, the partial reflectors (i) disposed at an oblique angle relative to the first primary glass surface and (ii) comprising a first partial reflector, a last partial reflector, and additional partial reflectors disposed spatially between the first partial reflector and the last partial reflector; and (2) an image source positioned to direct electromagnetic radiation into the lightguide so that the electromagnetic radiation encounters the first partial reflector before any other of the partial reflectors, wherein, the lightguide is free of adhesive disposed within the glass thickness.

According to a twenty-sixth aspect of the present disclosure, a method of manufacturing a lightguide for a visual augmented reality device comprises: (a) a polymer deposition step comprising depositing a first polymer region onto a first glass primary surface of a glass substrate, the first polymer region comprising an initial polymer primary surface and a second polymer primary surface, wherein the second polymer primary surface faces the first glass primary surface, and the initial polymer primary surface faces away from the second polymer primary surface; (b) an imprinting step comprising imprinting a series of sawtooth projections into the first polymer region at the initial polymer primary surface, each of the sawtooth projections comprising (i) a first angled surface that forms an oblique angle relative to the second polymer primary surface, the first angled surface open to an external environment, and (ii) a second angled surface that forms an approximately right angle or acute angle relative to the second polymer primary surface; (c) a reflector formation step comprising depositing a partial reflector onto the first angled surface of each of the sawtooth projections; and (d) a covering step comprising depositing a second polymer region over the first polymer region with the series of sawtooth projections and the partial reflectors thereupon to form an encapsulating polymer layer that encapsulates the partial reflectors, the second polymer layer providing a first polymer primary surface of the encapsulating polymer layer that is open to the external environment.

According to a twenty-seventh aspect of the present disclosure, the method of the twenty-sixth aspect is presented, wherein during the imprinting step, a mold is utilized to imprint the series of sawtooth projections into the first polymer region.

According to a twenty-eighth aspect of the present disclosure, the method of any one of the twenty-sixth through twenty-seventh aspects is presented, wherein the sawtooth projections comprise a first sawtooth projection, a last sawtooth projection, and additional sawtooth projections disposed spatially between the first sawtooth projection and the last sawtooth projection.

According to a twenty-ninth aspect of the present disclosure, the method of any one of the twenty-sixth through twenty-eighth aspects is presented, wherein during the reflector formation step, a line-of-sight deposition process is utilized to deposit the partial reflector.

According to a thirtieth aspect of the present disclosure, the method of any one of the twenty-sixth through twenty-ninth aspects is presented, wherein during the reflector formation step, the partial reflectors are substantially not deposited onto the second angled surface of any of the sawtooth projections.

According to a thirty-first aspect of the present disclosure, the method of any one of the twenty-sixth through thirtieth aspects is presented, wherein during the reflector formation step, collimators are disposed between a source material for the partial reflector and the sawtooth projections to direct the deposition of the source material to form the partial reflector onto the first angled surface but not the second angled surface of the sawtooth projections.

According to a thirty-second aspect of the present disclosure, the method of any one of the twenty-sixth through thirty-first aspects is presented, wherein during the reflector formation step, ion beam etching is utilized to remove the partial reflector formed on the second angled surface of the sawtooth projections.

According to a thirty-third aspect of the present disclosure, the method of any one of the twenty-sixth through thirty-second aspects is presented, wherein during the reflector formation step, alternating layers of a high-index material and a low-index material are applied in sequence.

According to a thirty-fourth aspect of the present disclosure, the method of the thirty-third aspect is presented, wherein during the application of at least one of the alternating layers during the reflector formation step, (i) a block with a slot aperture is disposed between a source material for whichever of the high-index material and the low-index material is being applied and the sawtooth projections, and (ii) the slot aperture is disposed relative to the sawtooth projections so that of all of the sawtooth projections, the first sawtooth projection receives the most of the source material, the last sawtooth projection receives the least of the source material, and the sawtooth projections between the first sawtooth projection and the last sawtooth projection receive sequentially less of the source material forming the at least one of the alternating layers as a function of relative distance from the first sawtooth projection.

According to a thirty-fifth aspect of the present disclosure, the method of the thirty-third aspect is presented, wherein during the application of at least one of the alternating layers during the reflector formation step, (i) a block with a set of parallel slot apertures is disposed between the source material for whichever of the high-index material and the low-index material is being applied and the sawtooth projections, each of the slot apertures having a different width, and the widths of the slot apertures sequentially decrease from the slot with the width that is the greatest to the slot with the width that is the least, and (ii) the parallel slot apertures are disposed relative to the sawtooth projections so that of all of the sawtooth projections, the first sawtooth projection receives the most of the source material, the last sawtooth projection receives the least of the source material, and the sawtooth projections between the first sawtooth projection and the last sawtooth projection receive sequentially less of the source material as a function of relative distance from the first sawtooth projection.

According to a thirty-sixth aspect of the present disclosure, the method of the thirty-third aspect is presented, wherein during the application of at least one of the alternating layers, (i) a block with a slot aperture is disposed between the source material for whichever of the high-index material and the low-index material is being applied and the sawtooth projections, and (ii) one or more of the slot aperture and the sawtooth projections is translated relative to the other with a varying speed so that of all of the sawtooth projections, the first sawtooth projection receives the most source material, the last sawtooth projection receives the least source material, and the sawtooth projections between the first sawtooth projection and the last sawtooth projection receive sequentially less of the source material as a function of relative distance from the first sawtooth projection.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of a lightguide of the present disclosure, illustrating a reflector region with buried partial reflectors;

FIG. 2 is an elevational cross-sectional view of the lightguide, illustrating a glass substrate and an encapsulating polymer layer disposed on the glass substrate;

FIG. 3 is a magnified view of area III of FIG. 2, illustrating the encapsulating polymer layer encapsulating the partial reflectors;

FIG. 4 is a magnified view of area IV of FIG. 3, illustrating the partial reflectors including alternating layers of a high-index material and a low-index material, each having a layer thickness;

FIG. 5 is an overhead view of a visual augmented reality device of the present disclosure, illustrating a frame holding a pair of lightguides of the present disclosure, a pair of image sources directing electromagnetic radiation into the lightguides, and the partial reflectors at the reflector region reflecting the electromagnetic radiation to a pair of eyes of a user;

FIG. 6 is a flow chart of a method of making the lightguide of the present disclosure, illustrating a polymer deposition step, an imprinting step, a reflector formation step, and a covering step;

FIG. 7 is a schematic diagram of the method, illustrating, for example, a polymer composition pouring from a container onto the glass substrate to form a first polymer region during the polymer deposition step;

FIG. 7A is a cross-sectional elevational view of a workpiece formed after the imprinting step, illustrating the first polymer region including sawtooth projections with a first angled surface and a second angled surface, the latter of which forms an approximately right angle relative to the first primary glass surface (or a plane parallel therewith);

FIG. 8 is a schematic diagram of an example of the reflector formation step, illustrating collimators directing source material toward the first primary glass surface of the sawtooth projections;

FIG. 9 is a schematic diagram of another example of the reflector formation step, illustrating a block with a slot aperture between the source material and the sawtooth projections, with the slot aperture sized and positioned so that the amount of the source material that the sawtooth projections receive decreases as a function of distance from a first sawtooth projection to a last sawtooth projection;

FIG. 10 is a schematic diagram of another example of the reflector formation step, illustrating a block including parallel slot apertures, each of the parallel slot apertures having a width associated with a different one of the sawtooth projections, and the widths narrowing sequentially so that the amount of the source material that the sawtooth projections receive decreases as a function of distance from a first sawtooth projection to a last sawtooth projection; and

FIG. 11 is a schematic diagram of another example of the reflector formation step, illustrating one or more of the block with the slot aperture and the workpiece with the sawtooth projections translating relative to the other so that the amount of the source material that the sawtooth projections receive decreases as a function of distance from a first sawtooth projection to a last sawtooth projection.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

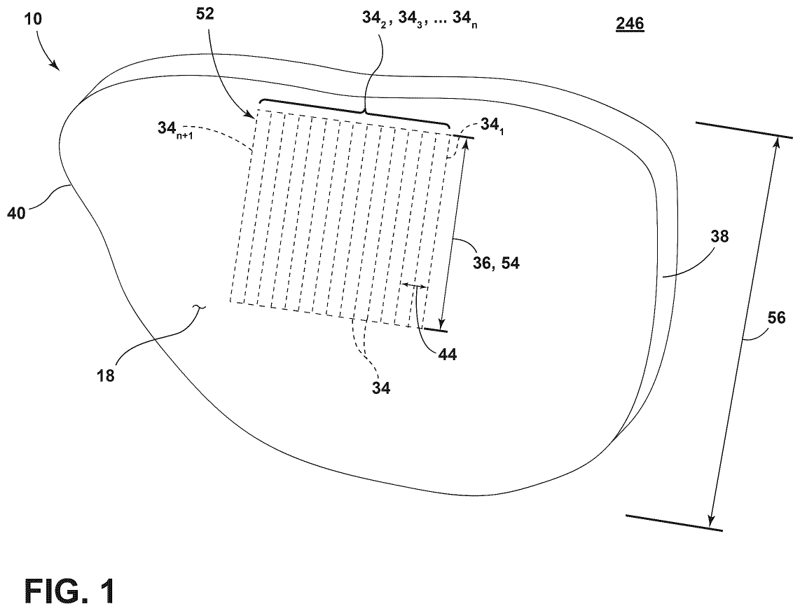

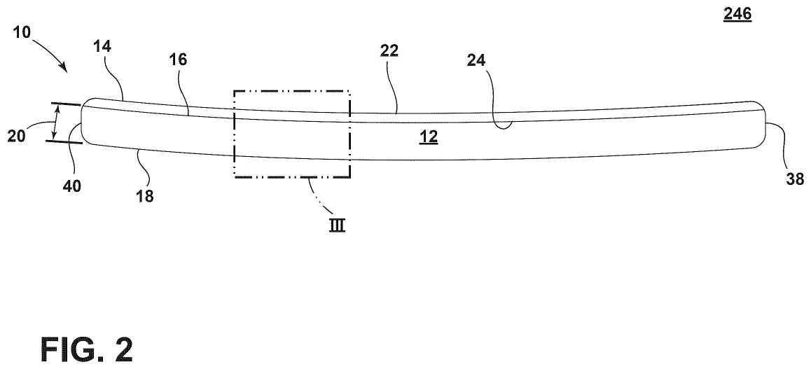

Referring to FIGS. 1-3, a lightguide 10 of the present disclosure is herein described. The lightguide 10 includes a glass substrate 12 and an encapsulating polymer layer 14. The glass substrate 12 includes a first glass primary surface 16 and a second glass primary surface 18. The first glass primary surface 16 and the second glass primary surface 18 face in opposite directions. The glass substrate 12 includes a composition. The composition of the glass substrate 12 can be a glass composition, a glass-ceramic composition, or a ceramic composition. The glass substrate 12 has a glass thickness 20, which is the shortest straight-line distance between the first glass primary surface 16 and the second glass primary surface 18.

In embodiments, the glass thickness 20 is within a range of from 0.3 mm to 5.0 mm. For example, the glass thickness 20 can be 0.3 mm, 0.4 mm, 0.5 mm, 0.6 mm, 0.7 mm, 0.8 mm, 0.9 mm, 1.0 mm, 1.2 mm, 1.4 mm, 1.5 mm, 1.6 mm, 1.8 mm, 2.0 mm, 2.2 mm, 2.4 mm, 2.6 mm, 2.8 mm, 3.0 mm, 3.2 mm, 3.4 mm, 3.6 mm, 3.8 mm, 4.0 mm, 4.2 mm, 4.4 mm, 4.6 mm, 4.8 mm, 5.0 mm, or within any range bound by any two of those values (e.g., from 0.5 to 1.5 mm, 1.0 mm to 2.0 mm, 0.3 mm to 0.8 mm, and so on). The glass thickness 20 can be less than 0.3 mm or greater than 5.0 mm. The glass substrate 12 is free of adhesive disposed within the glass thickness 20.

The encapsulating polymer layer 14 is disposed on the first glass primary surface 16. The encapsulating polymer layer 14 includes a first polymer primary surface 22 and a second polymer primary surface 24. The second polymer primary surface 24 faces the first glass primary surface 16. The first polymer primary surface 22 and the second polymer primary surface 24 face in generally opposite directions. The encapsulating polymer layer 14 has a polymer composition. The encapsulating polymer layer 14 has a polymer thickness 26, which is the straight-line distance between the first polymer primary surface 22 and the second polymer primary surface 24 orthogonal to the second glass primary surface 18. In embodiments, the polymer thickness 26 is less than or equal to 250 μm. For example, the polymer thickness 26 can be less than 1 μm, 1 μm, 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, or within any range bound by any two of those values (e.g, from 100 μm to 200 μm, from 110 μm to 240 μm, and so on). The lightguide 10 has a lightguide thickness 28, which is the shortest straight-line distance between the first polymer primary surface 22 and the second glass primary surface 18.

The glass substrate 12 exhibits a glass refractive index. The encapsulating polymer layer 14 exhibits a polymer refractive index. The glass substrate 12 and the encapsulating polymer layer 14 are substantially index-matched, which means here that an absolute value of a difference between the glass refractive index and the polymer refractive index is less than 0.20, such as less than 0.10, less than 0.05, less than 0.03, or even less than 0.01. For example, the absolute value of the difference between the glass refractive index and the polymer refractive index is 0, 0.0, greater than 0.0, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, or within any range bound by any two of those values (e.g., from 0.05 to 0.15, from 0.02 to 0.14, and so on).

In embodiments, the glass refractive index and the polymer refractive index are each within a range of from 1.40 to 2.30. “Refractive index” in this disclosure refers to the index of refraction of the layer or material mentioned. Values for the refractive index are as determined at room temperature and for electromagnetic radiation having a wavelength of 589 nm. In embodiments, the glass refractive index is 1.40, 1.45, 1.50, 1.55, 1.60, 1.65, 1.70, 1.75, 1.80, 1.85, 1.90, 1.95, 2.00, 2.05, 2.10, 2.15, 2.20, or within any range bound by any two of those values (e.g., from 1.50 to 1.95, from 1.55 to 2.10, and so on). In embodiments, the polymer refractive index is 1.40, 1.45, 1.50, 1.55, 1.60, 1.65, 1.70, 1.75, 1.80, 1.85, 1.90, 1.95, 2.00, 2.05, 2.10, 2.15, 2.20, or within any range bound by any two of those values (e.g., from 1.50 to 1.95, from 1.55 to 2.10, and so on).

In embodiments, the encapsulating polymer layer 14 includes a first polymer region 30 and a second polymer region 32. The first polymer region 30 provides the second polymer primary surface 24. The second polymer region 32 provides the first polymer primary surface 22. The first polymer region 30 is sandwiched between the glass substrate 12 and the second polymer region 32. The first polymer region 30 and the second polymer region 32 are contiguous with each other. In some instances, the first polymer region 30 and the second polymer region 32 share the same polymer composition. In other instances, the second polymer region 32 and the first polymer region 30 have different polymer compositions. However, in such instances, the first polymer region 30 and the second polymer region 32 exhibit polymer indices of refraction that are substantially the same (e.g., within 0.05 of each other).

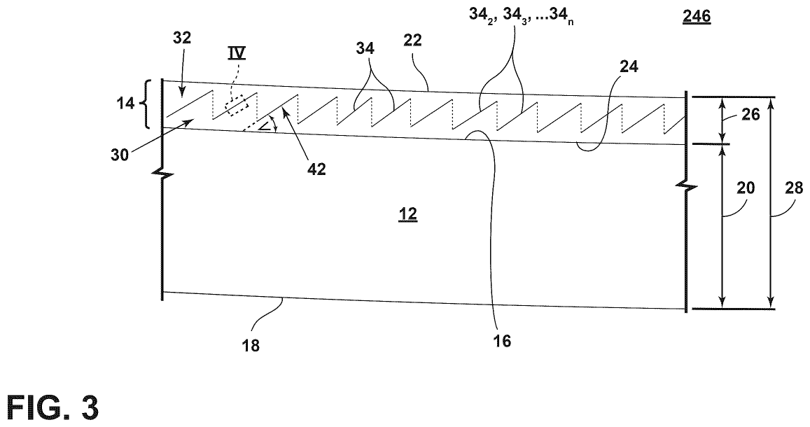

Referring additionally to FIG. 3, the lightguide 10 further includes partial reflectors 34. The partial reflectors 34 are disposed within the polymer thickness 26. The partial reflectors 34 are disposed closer to the first glass primary surface 16 than the second glass primary surface 18. In some embodiments, the first glass primary surface 16 over which the partial reflectors 34 are disposed is non-planar. For example, the first glass primary surface 16 can have a curvature.

The partial reflectors 34 each have a reflector length 36 (FIG. 1) extending into and out of the illustration of FIG. 3. In some embodiments, each of the partial reflectors 34 is curved along the reflector length 36. For example, from the perspective of one side 38 of the lightguide 10, the partial reflectors 34 are convex, and from the perspective of another side 40 of the lightguide 10, the partial reflectors 34 are concave.

The partial reflectors 34 are disposed at an oblique angle 2 relative to first glass primary surface 16. In embodiments that include the first polymer region 30 and the second polymer region 32, each of the partial reflectors 34 is disposed therebetween. In embodiments, the partial reflectors 34 are disposed substantially parallel to each other. In embodiments, each of the partial reflectors 34 includes a glass facing side 42 where the oblique angle ∠ has a value of less than 90° relative to the first glass primary surface 16. For example, the value of the oblique angle ∠ for each of the partial reflectors 34 can be within a range of from 10 degrees to 45 degrees.

The partial reflectors 34 include a first partial reflector 34₁, a last partial reflector 34ₙ₊₁, and additional partial reflectors 34₂, 34₃, . . . 34ₙ disposed spatially between the first partial reflector 34₁ and the last partial reflector 34ₙ₊₁. In embodiments, the value of the oblique angle ∠ for the additional partial reflectors 34₂, 34₃, . . . 34ₙ and the last partial reflector 34ₙ₊₁ changes as a function of distance 44 from the first partial reflector 34₁.

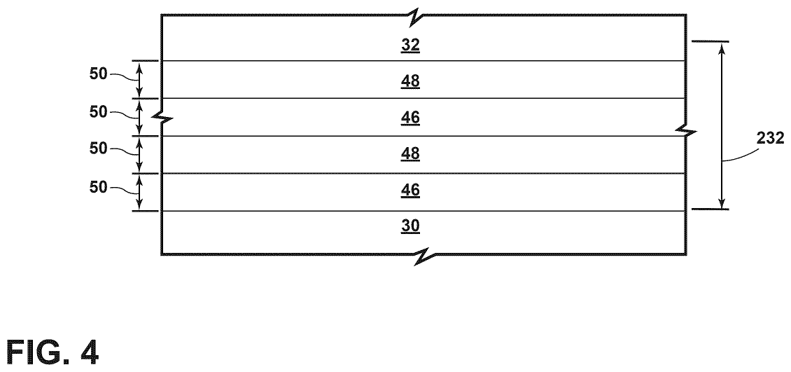

Referring now to FIG. 4, in embodiments, each of the partial reflectors 34 includes alternating layers of a high-index material 46 and a low-index material 48. “High-index” and “low-index” refer to the indices of refraction of the materials, with the high-index material 46 exhibiting an index of refraction that is greater than an index of refraction that the low-index material 48 exhibits. In embodiments, the index of refraction of the low-index material 48 is within a range of from 1.40 to 1.65. For example, the index of refraction of the low-index material 48 can be 1.40, 1.45, 1.50, 1.55, 1.60, 1.65, or within any range bound by any two of those values (e.g., from 1.45 to 1.60, from 1.50 to 1.65, and so on). In embodiments, the index of refraction of the high-index material 46 is within a range of from 1.66 to 2.60. For example, the index of refraction of the high-index material 46 can be 1.66, 1.70, 1.80, 1.90, 2.00, 2.10, 2.20, 2.30, 2.40, 2.50, 2.60, or within any range bound by any two of those values (e.g., from 1.80 to 2.20, from 1.90 to 2.40, and so on). Examples for the low-index-material 44 include SiO₂, MgF₂, YF₃, and YbF₃. Examples for the high-index material 46 include ZrO₂, HfO₂, Ta₂O₅, Nb₂O₅, TiO₂, Y₂O₃, Si₃N₄, SrTiO₃, WO₃, SiᵤAlᵥOₓN_{y}, AlNₓ, Si₃N₄, AlOₓN_{y}, SiOₓN_{y}, SiNₓ, SiNₓ: H_{y}, Al₂O₃, and MoO₃.

Each of the alternating layers of the high-index material 46 and the low-index material 48 have layer thicknesses 50, which can all be different. In embodiments, the layer thickness 50 of each of the alternating layers of the high-index material 46 and the low-index material 48 is within a range of from 10 nm to 250 nm, or 20 nm to 200 nm, or 30 nm to 150 nm, or 40 nm to 120 nm. For example, the layer thickness 50 of each of the alternating layers of the high-index material 46 and the low-index material 48 can be 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, or within any range bound by any two of those values (e.g., from 40 nm to 70 nm, from 50 nm to 100 nm, and so on). The layer thickness 50 of the alternating layers of the high-index material 46 and the low-index material 48 may be the same or different. In embodiments, the layer thicknesses 50 of each of the alternating layers of the high-index material 46 and the low-index material 48, the first refractive index, and the second refractive index are collectively configured so that each of the partial reflectors 34 exhibits one or more predetermined reflectances of electromagnetic radiation at a wavelength within the visible spectrum, which corresponds to the wavelength range from 400 nm to 700 nm. For example, with the first refractive index and the second refractive index being a property of the low-index material 48 and the high-index material 46 selected, the layer thicknesses 50 of each of the alternating layers of the high-index material 46 and the low-index material 48 can be engineered, based on constructive interference, to provide a predetermined reflectance for a target wavelength or wavelength range of electromagnetic radiation.

In embodiments, the reflectance that the partial reflectors 34 exhibit increases from the first partial reflector 34₁ to the last partial reflector 34ₙ₊₁. For example, the reflectance that the partial reflectors 34 exhibit can increase exponentially from the first partial reflector 34₁ to the last partial reflector 34ₙ₊₁. Beginning with the first partial reflector 34₁ and moving away therefrom, each of the partial reflectors 34 causes some of the electromagnetic radiation to exit the lightguide 10. Thus, less electromagnetic radiation (e.g., injected into the lightguide 10 from an image source 102) remains within the lightguide 10 after being reflected out of the lightguide 10 by each of the partial reflectors 34 moving away from the first partial reflector 34₁. Thus, reflectance of the partial reflectors 34 should increase as a function of the distance 44 from the first partial reflector 34₁. Otherwise, the perceived image from the lightguide 10 would increase in brightness as a function of position toward the first partial reflector 34₁. The reflectance that each of the partial reflectors 34 exhibits can be within a range of from greater than 0% to 80%. For instance, each of the partial reflectors 34 can separately exhibit a reflectance of greater than 0%, 5%, 10%, 15%, 20%, 25%, 30%, 35%, 40%, 45%, 50%, 55%, 60%, 65%, 70%, 75%, 80%, or within any range bound by any two of those values (e.g., from 10% to 65%, from 35% to 45%, and so on). In embodiments, to achieve the increase in reflectance moving sequentially from the first partial reflector 34₁ to the last partial reflector 34ₙ₊₁, the layer thickness 50 of at least one of the alternating layers of the high-index material 46 and the low-index material 48 increases or decreases sequentially from the first partial reflector 34₁ to the last partial reflector 34ₙ₊₁. For example, the layer thickness 50 of the low-index material 48 disposed closest to the glass substrate 12 can be made to increase (or decrease) sequentially from the first partial reflector 34 to the last partial reflector 34. That is just an example, and it could be the layer thickness 50 of the high-index material 46 (or both the layer thickness 50 of the low-index material 48 and the layer thickness 50 of the high-index material 46) that is (are) made to increase or decrease sequentially from the first partial reflector 34₁ to the last partial reflector 34ₙ₊₁ in order to provide the increase in reflectance from first partial reflector 34 moving to the last partial reflector 34ₙ₊₁.

The partial reflectors 34 are disposed within a reflector region 52 (see FIG. 1). The reflector region 52 has a reflector linear dimension 54, which can be coextensive with the reflector length 36, that encompasses all the partial reflectors 34. The lightguide 10 has a lightguide linear dimension 56 that is parallel to the reflector linear dimension 54. The reflector linear dimension 54 and lightguide linear dimension 56 can be substantially the same. However, in embodiments, the reflector linear dimension 54 is only a percentage of the lightguide linear dimension 56. For example, the percentage can be 10%, 20%, 30%, 40%, 50%, 60%, 70%, 80%, 90%, or less than 100%.

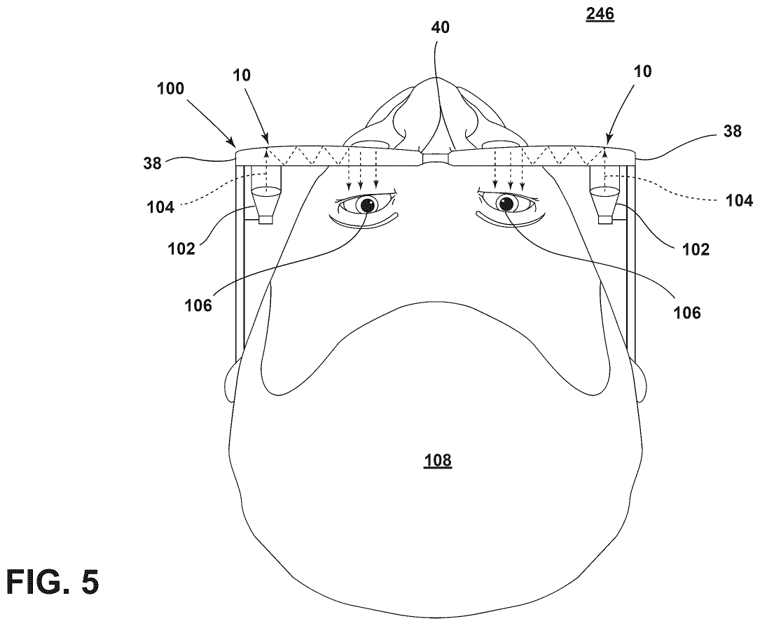

The lightguide 10 has a variety of applications. Referring now to FIG. 5, among them, a visual augmented reality device 100 incorporates the lightguide 10 and an image source 102. The image source 102 is positioned to direct electromagnetic radiation 104 into the lightguide 10 so that the electromagnetic radiation 104 encounters the first partial reflector 34₁ before any other of the additional partial reflectors 34₂, 34₃, . . . 34ₙ. The electromagnetic radiation 104 that the image source 102 injects into the lightguide 10 reflects repeatedly within the lightguide 10 until the partial reflectors 34 cause the electromagnetic radiation 104 to exit the second glass primary surface 18 to be incident to an eye 106 of a user 108 wearing the visual augmented reality device 100. Consequently, the user 108 can sense the electromagnetic radiation 104 (within the visual spectrum) as a virtual image and the external world image, also transmitted through the lightguide 10, in a superimposed manner. The user 108 wears the visual augmented reality device 100 on a head of the user 108. The image source 102 can be an LCD, an OLED, or some other micro-display.

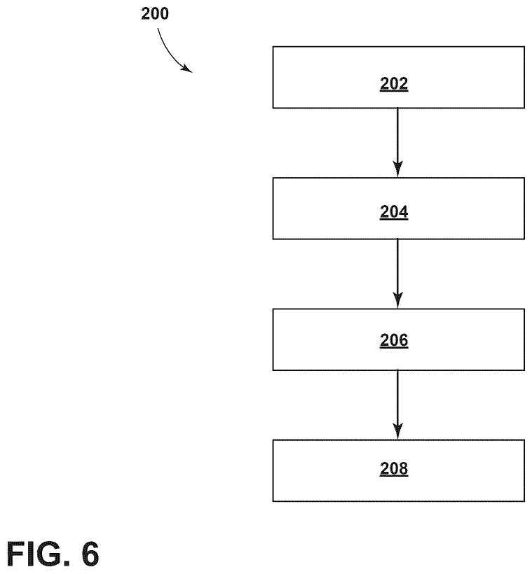

Referring now to FIG. 6, a method 200 of manufacturing the lightguide 10 is herein described. The method 200 includes a polymer deposition step 202, an imprinting step 204, a reflector formation step 206, and a covering step 208. Each of these steps of the method 200 will be further elaborated upon below.

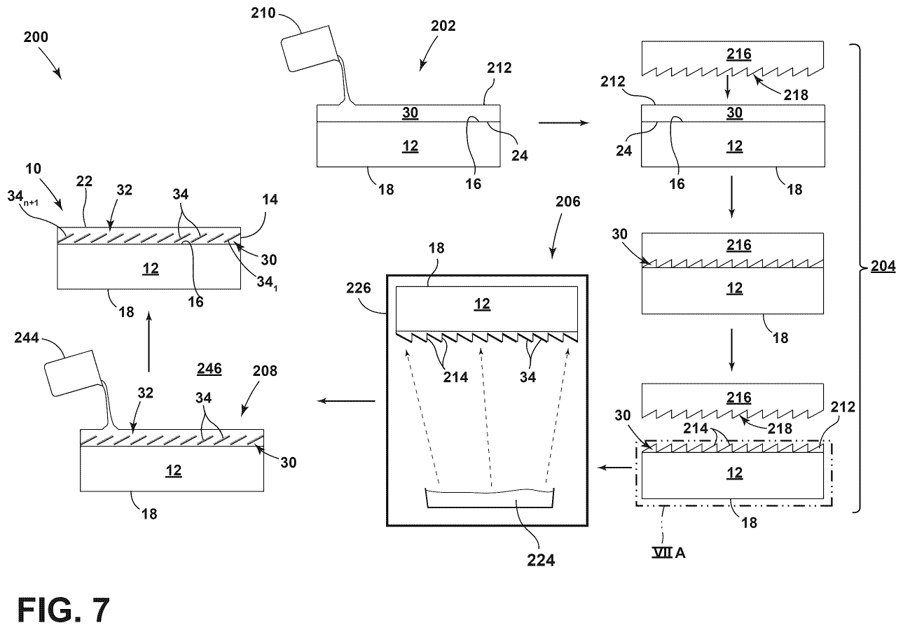

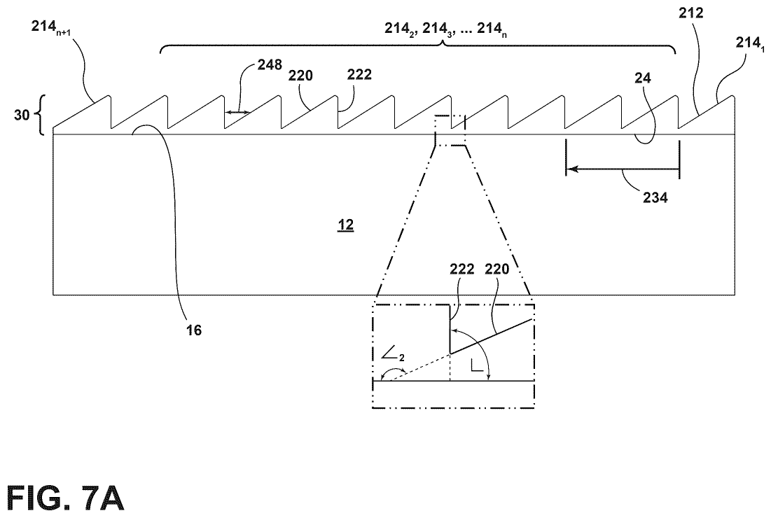

Referring now to FIGS. 7 and 7A, the polymer deposition step 202 includes depositing the first polymer region 30 as a layer onto the first glass primary surface 16 of the glass substrate 12. When deposited, the polymer composition of the first polymer region 30 has a low enough viscosity to flow from a container 210 of the polymer composition to upon the first glass primary surface 16 and spread out thereupon as a layer. In some instances, the polymer composition can be heated to decrease the viscosity sufficiently to flow. In other instances, a degree of polymerization of the polymer composition increases after being applied onto the first glass primary surface 16 to form the first polymer region 30. The first polymer region 30 provides an initial polymer primary surface 212 and the second polymer primary surface 24. The initial polymer primary surface 212 faces away from the second polymer primary surface 24.

The imprinting step 204 includes imprinting a series of sawtooth projections 214 into the first polymer region 30 at the initial polymer primary surface 212. In embodiments, a mold 216 is utilized to imprint the series of sawtooth projections 214 into the first polymer region 30. The mold 216 in such embodiments has a negative 218 of the sawtooth projections 214. The negative 218 of the sawtooth projections 214 can be formed into the mold 216 via diamond machining or direct laser writing (e.g., using gray scale lithography). Both diamond machining and direct laser writing can produce smooth optical quality surfaces, which are then transferred to the first polymer region 30.

The negative 218 of the sawtooth projections 214 can be forced into the first polymer region 30 at the initial polymer primary surface 212. The forcing of the mold 216 into the first polymer region 30 causes the first polymer region 30 to conform to the negative 218 of the sawtooth projections 214. The mold 216 is thereafter released from the first polymer region 30. The first polymer region 30 has the sawtooth projections 214 after conforming to the mold 216. Each of the sawtooth projections 214 includes a first angled surface 220 and a second angled surface 222. The first angled surface 220 forms an oblique angle ∠₂ (e.g., an obtuse angle) relative to the second polymer primary surface 24. The second angled surface 222 forms an approximately right angle └ relative to the second polymer primary surface 24. The sawtooth projections 214 include a first sawtooth projection 214₁, a last sawtooth projection 214ₙ₊₁, and additional sawtooth projections 214₂, 214₃, . . . 214ₙ disposed spatially between the first sawtooth projection 214₁ and the last sawtooth projection 214ₙ₊₁.

The reflector formation step 206 includes depositing one of the partial reflectors 34 onto the first angled surface 220 of each of the sawtooth projections 214. In embodiments, a line-of-sight deposition process can be utilized to deposit the partial reflectors 34. Examples of such line-of-sight deposition processes include thermal evaporation and sputtering (e.g., physical vapor deposition). Source material 224 for the partial reflectors 34 (e.g., source material 224 for the high-index material 46 or the low-index material 48) can be caused to thermally evaporate such as by heating with a resistive heat element. The thermal evaporation can occur in a vacuum chamber 226. The evaporated source material 224 then condenses upon the first angled surface 220 as the partial reflector 34 or a layer thereof (e.g., of the high-index material 46 or the low-index material 48). In embodiments, multiple layers are applied in sequence, such as alternating layers of the high-index material 46 and the low-index material 48.

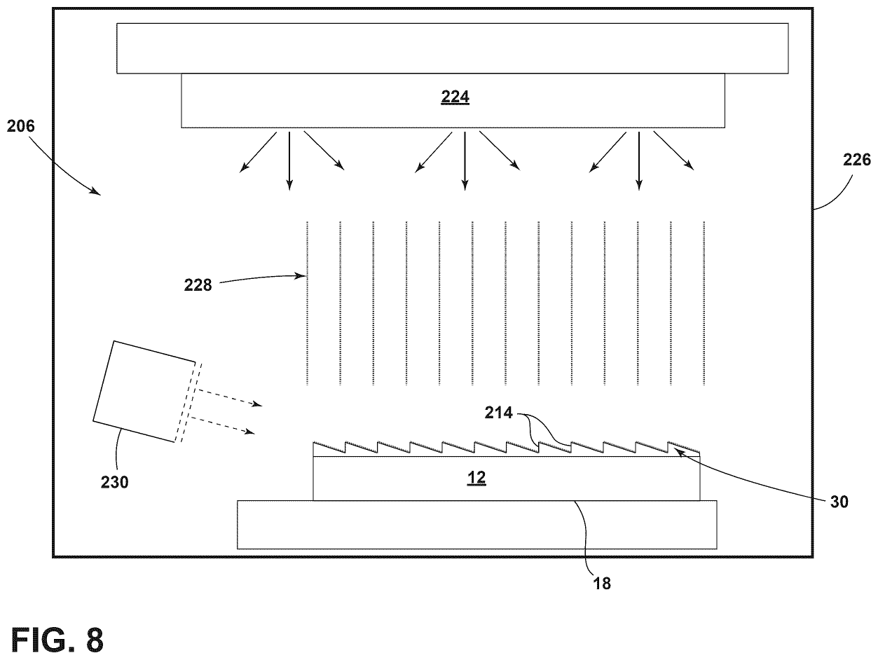

During the reflector formation step 206, the partial reflectors 34 are substantially not deposited onto the second angled surface 222 of any of the sawtooth projections 214. Referring additionally to FIG. 8, in embodiments, to help facilitate the absence of the partial reflectors 34 on the second angled surface 222 of the sawtooth projections 214, collimators 228 are disposed between the source material 224 for the partial reflectors 34 (e.g., high-index material 46 or low-index material 48) and the sawtooth projections 214 to direct the deposition of the source material 224 to form the partial reflectors 34 onto the first angled surface 220 but not the second angled surface 222 of the sawtooth projections 214. The collimators 228 can be aligned substantially parallel to the second angled surfaces 222. To the extent that the deposition process utilized causes the deposition of material on the second angled surfaces 222, ion beam etching can be utilized to remove the deposited material (e.g., the partial reflector or the deposited one of the alternating layers) formed on the second angled surface 222 of the sawtooth projections 214. A Kaufmann ion thruster 230 can be positioned to emit ions (e.g., of argon) substantially parallel to the first angled surface 220, as in the illustration. The emitted ions impact the second angled surfaces 222 and remove deposited material thereupon. Instead of ion beam etching, reactive ion etching can be utilized. In such cases, the second angled surfaces 222 can be aligned substantially orthogonally to the electric field and path of travel of the reactive species. More material would then be removed from the second angled surfaces 222 than the first angled surfaces 220. Such a routine could also be implemented to deposit each of the alternating layers of the high-index material 46 and the low-index material 48 via a plasma enhanced chemical vapor deposition process and then removing the deposited material from the second angled surfaces 222 via reactive ion etching.

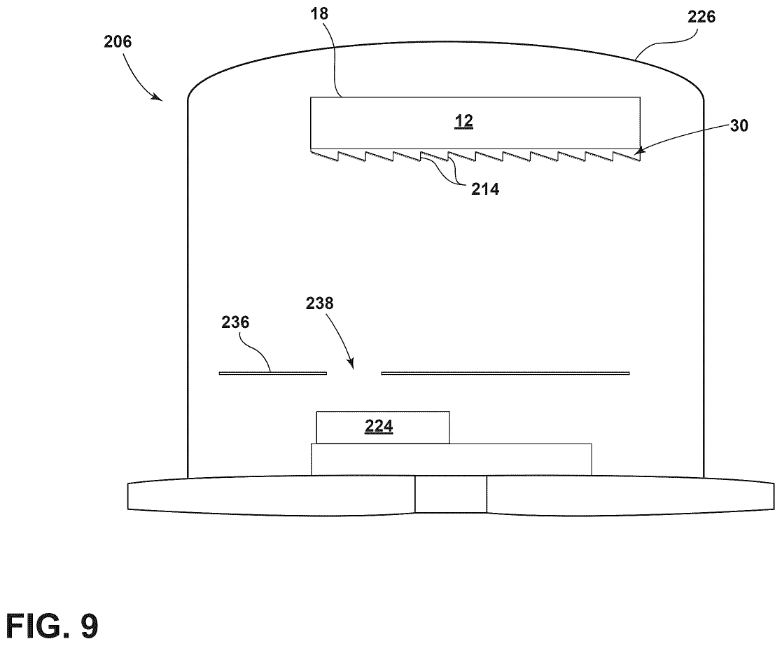

As mentioned above, in embodiments, the reflectance that the partial reflectors 34 exhibit increases sequentially from the first partial reflector 34₁ to the last partial reflector 34ₙ₊₁. That can be achieved by manipulating a thickness 232 (see FIG. 4) of the partial reflectors 34, or the layer thickness 50 of one or more of the alternating layers of the high-index material 46 and low-index material 48, added to the first angled surface 220 as a function of distance 234 (FIG. 7A) from the first sawtooth projection 214₁. As one example, referring to FIG. 9, a block 236 with a slot aperture 238 is disposed between the source material 224 for whichever of the high-index material 46 and low-index material 48 is being applied and the sawtooth projections 214. The slot aperture 238 is disposed relative to the sawtooth projections 214 so that of all of the sawtooth projections 214, the first sawtooth projection 214₁ receives the most of the source material 224, the last sawtooth projection 214ₙ₊₁ receives the least of the source material 224, and the additional sawtooth projections 214₂, 214₃, . . . 214ₙ between first sawtooth projection 214₁ and the last sawtooth projection 214ₙ₊₁ receive sequentially less of the source material 224 forming the partial reflectors 34 as a function of the distance 234 from the first sawtooth projection 214₁. Alternatively, the slot aperture 238 can be disposed relative to the sawtooth projections 214 so that of all of the sawtooth projections 214, the first sawtooth projection 214₁ receives the least of the source material 224, the last sawtooth projection 214ₙ₊₁ receives the most of the source material 224, and the additional sawtooth projections 214₂, 214₃, . . . 214ₙ between first sawtooth projection 214₁ and the last sawtooth projection 214ₙ₊₁ receive sequentially more of the source material 224 forming the at least one of the alternating layers of the high-index material 46 and low-index material 48 as a function of the distance from the first sawtooth projection 214₁. In the embodiments of the reflector formation step 206 described herein, “first” and “last” of first sawtooth projection 214₁ and last sawtooth projection 214ₙ₊₁ are to denote positioning relative to each other and the additional sawtooth projections 214₂, 214₃, . . . 214ₙ and not to denote positioning relative to any external reference point.

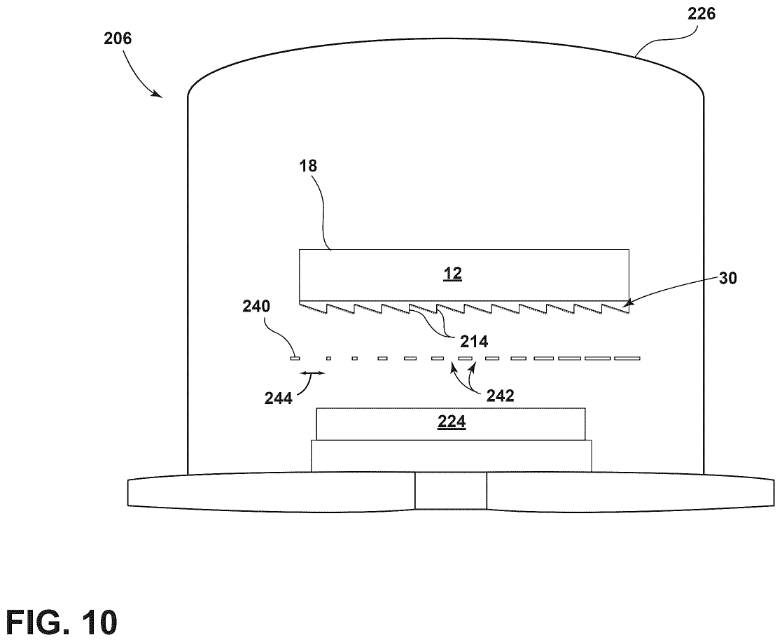

As another example, referring to FIG. 10, during the application of at least one of the alternating layers, a block 240 with a set of parallel slot apertures 242 is disposed between the source material 224 for whichever of the high-index material 46 and low-index material 48 is being applied and the sawtooth projections 214. Each of the slot apertures 242 has a different width 244. The widths 244 of the slot apertures 242 sequentially decrease from the slot with the width 244 that is the greatest to the slot with the width 244 that is the least. The parallel slot apertures 242 are disposed relative to the sawtooth projections 214 so that of all of the sawtooth projections 214, the first sawtooth projection 214₁ receives the most of the source material 224, the last sawtooth projection 214ₙ₊₁ receives the least of the source material 224, and the additional sawtooth projections 214₂, 214₃, . . . 214ₙ between the first sawtooth projection 214₁ and the last sawtooth projection 214ₙ₊₁ receive sequentially less of the source material 224 as a function of the distance 234 from the first sawtooth projection 214₁. The parallel slot aperture 238 with the widest width 244 is associated with the first sawtooth projection 214₁ and the parallel slot aperture 238 with the narrowest width 244 is associated with the last sawtooth projection 214ₙ₊₁. Alternatively, the parallel slot apertures 242 can be disposed relative to the sawtooth projections 214 so that of all of the sawtooth projections 214, the first sawtooth projection 214₁ receives the least of the source material 224, the last sawtooth projection 214ₙ₊₁ receives the most of the source material 224, and the sawtooth projections 214 between first sawtooth projection 214₁ and the last sawtooth projection 214ₙ₊₁ receive sequentially more of the source material 224 as a function of the distance 234 from the first sawtooth projection 214₁. In that scenario, the parallel slot aperture 238 with the narrowest width 244 is associated with the first sawtooth projection 214₁ and the parallel slot aperture 238 with the widest width 244 is associated with the last sawtooth projection 214ₙ₊₁.

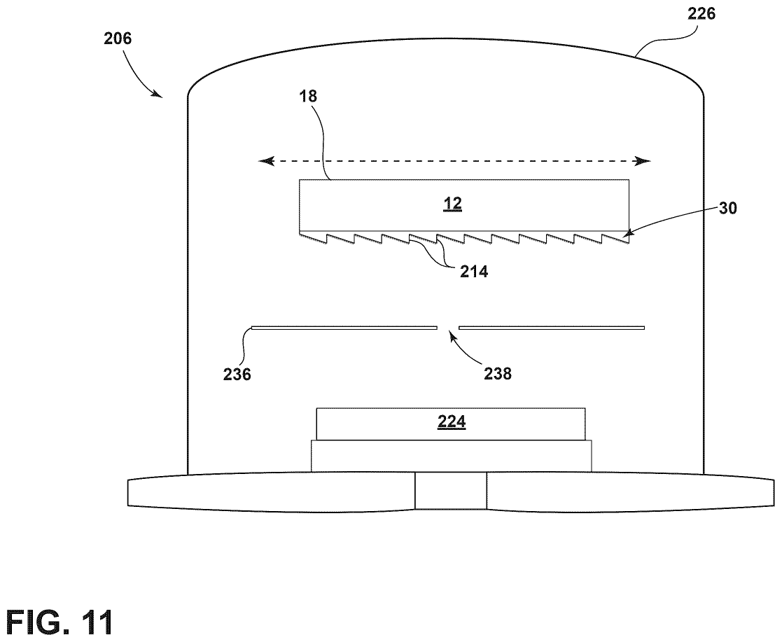

As still another example, referring to FIG. 11, during the application of at least one of the alternating layers of the high-index material 46 and low-index material 48, the block 236 with a slot aperture 238 is again disposed between the source material 224 for whichever of the high-index material 46 and low-index material 48 is being applied and the sawtooth projections 214. One or more of the slot aperture 238 and the sawtooth projections 214 is translated relative to the other with a varying speed so that of all of the sawtooth projections 214, the first sawtooth projection 214₁ receives the most of the source material 224, the last sawtooth projection 214ₙ₊₁ receives the least of the source material 224, and the additional sawtooth projections 214₂, 214₃, . . . 214ₙ between the first sawtooth projection 214₁ and the last sawtooth projection 214ₙ₊₁ receive sequentially less of the source material 224 as a function of the distance 234 from the first sawtooth projection 214₁. Alternatively, one or more of the slot aperture 238 and the sawtooth projections 214 is translated relative to the other with a varying speed so that of all of the sawtooth projections 214, the first sawtooth projection 214₁ receives the least of the source material 224, the last sawtooth projection 214ₙ₊₁ receives the most of the source material 224, and the additional sawtooth projections 214₂, 214₃, . . . 214ₙ between the first sawtooth projection 214₁ and the last sawtooth projection 214ₙ₊₁ receive sequentially more of the source material 224 as a function of the distance 234 from the first sawtooth projection 214₁.

As mentioned, referring back to FIG. 7, the method 200 further includes the covering step 208. The covering step 208 includes depositing the second polymer region 32, as a layer, over the first polymer region 30 with the series of sawtooth projections 214 and the partial reflectors 34 thereupon. As with the polymer deposition step 202, the polymer composition of the second polymer region 32 has a sufficiently low viscosity to flow from a container 244 of the polymer composition to upon the first polymer region 30. In some instances, the polymer composition can be heated to decrease the viscosity sufficiently to flow or the polymer composition can be further polymerized while upon the first polymer region 30. As a result, the series of sawtooth projections 214 and the partial reflectors 34 are encapsulated between the glass substrate 12 and the second polymer region 32. More particularly, the partial reflectors 34 are encapsulated between the first polymer region 30 and the second polymer region 32, and the series of sawtooth projections 214 becomes indistinguishable as the first polymer region 30 and the second polymer region 32 form contiguously the encapsulating polymer layer 14. The second polymer region 32 provides the first polymer primary surface 22 open to an external environment 246. The second polymer region 32 fills in the gaps 248 (see FIG. 7A) between the sawtooth projections 214 of the first polymer region 30 parallel to the first glass primary surface 16 and buries the partial reflectors 34 below the first polymer primary surface 22. The polymer composition forming the first polymer region 30 and the polymer forming the second polymer region 32 can be the same. If desirable for the application of the lightguide 10, the polymer composition of the second polymer region 32 can have a viscosity of about 200 cps (centipoise) or less when applied over the first polymer region 30, which would allow the second polymer region 32 to spread and self-level to form the first polymer primary surface 22 due to surface tension. Alternatively, mechanical force can be applied to the second polymer region 32 to form and/or smooth the first polymer primary surface 22. The first polymer region 30 and the second polymer region 32 together form the encapsulating polymer layer 14 of the lightguide 10.

The lightguide 10 and the method 200 of the present disclosure address the problem set forth in the Background, and other problems, in a variety of ways. Among them, the partial reflectors 34 are encapsulated within the encapsulating polymer layer 14, as having been deposited upon the sawtooth projections 214 of the first polymer region 30 during the reflector formation step 206 and then covered with the second polymer region 32 during the covering step 208. The prior art method 200 of coating glass plates, fusing the coated glass plates together as a stack with an adhesive, and then slicing the stack at an angle is avoided. As a consequence, the partial reflectors 34 of the lightguide 10 of the present disclosure do not extend entirely through the lightguide thickness 28 but only extend within a portion of the polymer thickness 26 of the encapsulating polymer layer 14 (that portion provided by the first polymer region 30). The imprinting step 204 forms the sawtooth projections 214 into a polymer composition (of the first polymer region 30). The covering step 208 fills in and covers the sawtooth projections with the self-leveling or mechanically pressed polymer composition of the second polymer region 32. The cost and expense of precisely grinding and polishing perfectly matching sawtooth projections into two glass layers is avoided.

Further, the method 200 of the present disclosure is much less costly and easier to scale than the prior art method described. The imprinting step 204 forms the sawtooth projections 214 into a polymer composition (of the first polymer region 30). The covering step 208 fills in and covers the sawtooth projections with the self-leveling polymer composition of the second polymer region 32. The cost and expense of precisely grinding and polishing perfectly matching sawtooth projections into two glass layers is avoided. The method 200 generates much less scrap as well, as there are no subtractive processes like the stack slicing process of the prior art method. The prior art method results in scrap on both sides of the lightguide 10 sawed from the stack.

It will be apparent to those skilled in the art that various modifications and variations can be made without departing from the spirit or scope of the claims.

What is claimed is:

1. A lightguide for a visual augmented reality device comprising:
a glass substrate comprising a first glass primary surface, a second glass primary surface, and a glass thickness between the first glass primary surface and the second glass primary surface, the first glass primary surface and the second glass primary surface facing in generally opposite directions;
an encapsulating polymer layer disposed on the first glass primary surface, the encapsulating polymer layer comprising a first polymer primary surface, a second polymer primary surface facing the first glass primary surface, and a polymer thickness between the first polymer primary surface and the second polymer primary surface, the first polymer primary surface and the second polymer primary surface facing in generally opposite directions; and
partial reflectors disposed within the polymer thickness, the partial reflectors disposed at an oblique angle relative to the first primary glass surface,
wherein, the lightguide is free of adhesive disposed within the glass thickness.

2. The lightguide of claim 1, wherein
the glass substrate exhibits a glass refractive index,
the encapsulating polymer layer exhibits a polymer refractive index, and
an absolute value of a difference between the glass refractive index and the polymer refractive index is less than 0.20.

3. The lightguide of claim 1, wherein the encapsulating polymer layer comprises (i) a first polymer region contiguous with the first polymer primary surface and (ii) a second polymer region contiguous with the second polymer primary surface.

4. The lightguide of claim 3, wherein each of the partial reflectors is disposed between the first polymer region and the second polymer region.

5. The lightguide of claim 1, wherein the first glass primary surface over which the partial deflectors are disposed is non-planar.

6. The lightguide of claim 1, wherein each of the partial reflectors is curved.

7. The lightguide of claim 1, wherein each of the partial reflectors comprises a glass facing side that forms an acute angle relative to the first glass primary surface.

8. The lightguide of claim 1, wherein the partial reflectors comprise a first partial reflector, a last partial reflector, and additional partial reflectors disposed spatially between the first partial reflector and the last partial reflector.

9. The lightguide of claim 8, wherein
each of the partial reflectors comprises a glass facing side that forms an acute angle relative to the first glass primary surface, and
a value of the acute angle for the additional partial reflectors and the last partial reflector changes as a function of distance from the first partial reflector.

10. The lightguide of claim 9, wherein the value of the acute angle for each of the partial reflectors is within a range of from 10 degrees to 45 degrees.

11. The lightguide of claim 8, wherein
each of the partial reflectors comprises alternating layers of a high-index material and a low-index material, and
the high-index material exhibits an index of refraction that is greater than an index of refraction that the low-index material exhibits.

12. The lightguide of claim 11, wherein
the index of refraction of the low-index material is within a range of from 1.40 to 1.65, and
the index of refraction of the high-index material is within a range of from 1.66 to 2.60.

13. The lightguide of claim 11, wherein
the low-index material comprises one or more of SiO₂, MgF₂, YF₃, and YbF₃, and
the high-index material comprises one or more of ZrO₂, HfO₂, Ta₂O₅, Nb₂O₅, TiO₂, Y₂O₃, Si₃N₄, SrTiO₃, WO₃, SiᵤAlᵥOₓN_{y}, AlNₓ, AlOₓN_{y}, SiOₓN_{y}, SiNₓ, SiNₓ:H_{y}, Al₂O₃, and MoO₃.

14. The lightguide of claim 11, wherein
each of the alternating layers comprises a layer thickness, and
the layer thickness of each of the alternating layers is within a range of 10 nm to 250 nm.

15. The lightguide of claim 14, wherein the layer thickness of at least one of the alternating layers increases or decreases sequentially from the first partial reflector to the last partial reflector.

16. The lightguide of claim 11, wherein the reflectance that the partial reflectors exhibit increases sequentially from the first partial reflector to the last partial reflector.

17. A visual augmented reality device comprising:
a lightguide comprising:
a glass substrate comprising a first glass primary surface, a second glass primary surface, and a glass thickness between the first glass primary surface and the second glass primary surface, the first glass primary surface and the second glass primary surface facing in generally opposite directions;
an encapsulating polymer layer disposed on the first glass primary surface, the encapsulating polymer layer comprising a first polymer primary surface, a second polymer primary surface facing the first glass primary surface, and a polymer thickness between the first polymer primary surface and the second polymer primary surface, the first polymer primary surface and the second polymer primary surface facing in generally opposite directions; and
partial reflectors disposed within the polymer thickness, the partial reflectors (i) disposed at an oblique angle relative to the first primary glass surface and (ii) comprising a first partial reflector, a last partial reflector, and additional partial reflectors disposed spatially between the first partial reflector and the last partial reflector; and
an image source positioned to direct electromagnetic radiation into the lightguide so that the electromagnetic radiation encounters the first partial reflector before any other of the partial reflectors,
wherein, the lightguide is free of adhesive disposed within the glass thickness.

18. A method of manufacturing a lightguide for a visual augmented reality device comprising:
a polymer deposition step comprising depositing a first polymer region onto a first glass primary surface of a glass substrate, the first polymer region comprising an initial polymer primary surface and a second polymer primary surface, wherein the second polymer primary surface faces the first glass primary surface, and the initial polymer primary surface faces away from the second polymer primary surface;
an imprinting step comprising imprinting a series of sawtooth projections into the first polymer region at the initial polymer primary surface, each of the sawtooth projections comprising (i) a first angled surface that forms an oblique angle relative to the second polymer primary surface, the first angled surface open to an external environment, and (ii) a second angled surface that forms an approximately right angle or acute angle relative to the second polymer primary surface;
a reflector formation step comprising depositing a partial reflector onto the first angled surface of each of the sawtooth projections; and
a covering step comprising depositing a second polymer region over the first polymer region with the series of sawtooth projections and the partial reflectors thereupon to form an encapsulating polymer layer that encapsulates the partial reflectors, the second polymer layer providing a first polymer primary surface of the encapsulating polymer layer that is open to the external environment.

19. The method of claim 18, wherein during the imprinting step, a mold is utilized to imprint the series of sawtooth projections into the first polymer region.

20. The method of claim 18, wherein during the reflector formation step, alternating layers of a high-index material and a low-index material are applied in sequence.
